(19) United States
(12) Patent Application Publication
(10) Pub. No.: US 2008/0271027 A1
(43) Pub. Date: Oct. 30, 2008

(54) Fair share scheduling with hardware multithreading

(76) Inventors: Scott J. Norton, San Jose, CA (US); Hyun Kim, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,511

(22) Filed: Apr. 27, 2007

(51) Int. Cl. G06F 9/46

(52) U.S. Cl. 718/103

(57) ABSTRACT

An embodiment of the invention provides an apparatus and method for fair share scheduling with hardware multithreading. The apparatus and method include the acts of: executing, by a first hardware thread in a processor core, a first software thread belonging to a fair share group; and permitting a second hardware thread in the processor core to execute a second software thread if that second software thread belongs to the fair share group.

### TECHNICAL FIELD

Embodiments of the invention relate generally to fair share scheduling with hardware multithreading.

### BACKGROUND

A multi-core processor architecture is implemented by a single processor that plugs directly into a single processor socket, and that single processor will have one or more “processor cores”. Those skilled in the art also refer to processor cores as “CPU cores”. The operating system perceives each processor core as a discrete logical processor. A multi-core processor can perform more work within a given clock cycle because computational work is spread over to the multiple processor cores.

Hardware threads are the one or more computational objects that share the resources of a core but architecturally look like a core from an application program's viewpoint. As noted above, a core is the one or more computational engines in a processor. Hardware multithreading (also known as HyperThreading) is a technology that allows a processor core to act like two or more separate “logical processors” or “computational objects” to the operating system and the application programs that use the processor core. In other words, when performing the multithreading process, a processor core executes, for example, two threads (streams) of instructions sent by the operating system, and the processor core appears to be two separate logical processors to the operating system. The processor core can perform more work during each clock cycle by executing multiple hardware threads. Each hardware thread typically has its own thread state, registers, stack pointer, and program counter.

As known to those skilled in the art, in an operating system, a fair share scheduler provides controls for the specific amounts of CPU execution time between different fair share groups. One or more processes will belong to each fair share group. Each fair share group is allocated specific amounts of time during which the processes in the fair share group are allowed to execute before the scheduler moves on to the next fair share group to allow execution of processes in the next group. In other words, each share group is entitled to a certain amount of time to use the CPU core resources. The entitlements to the CPU core resources among the fair share groups may vary in amounts or may be equal in amounts, and can be amounts that are set by the user.

On computing systems that contain hardware multithreaded CPU cores, it is extremely difficult to accurately measure the amount of time that an application thread (software thread) has actually used in the CPU since the CPU core is being shared with two application threads, and an application thread is sometimes running in parallel with the other application thread. Furthermore, some hardware systems do not allow the accurate measurement of time accounting information on a per hardware thread basis, where the time accounting information is the time amount that is executed by the task which can be a software thread. This further complicates an accurate fair share scheduling which intends to provide entitlements to the CPU core resources among the share groups. These hardware systems do not indicate if proper entitlements are being given among the share groups such as when, for example, a process from a share group is being given 90% of the resources of a hardware thread in a CPU core while another process in a different share group is being given only 10% of the resources of another hardware thread in the CPU core. In this scenario, both share groups are not optimally given the entire (or 100%) of the core resources when the processes of the fair share groups are executing. Therefore, these prior systems do not necessarily provide a proper entitlement of CPU core resources to the fair share groups and also do not provide an accurate measurement of the core resource entitlements that are given to the fair share groups.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus) in accordance with an embodiment of the invention.

FIG. 2 is a flow diagram of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

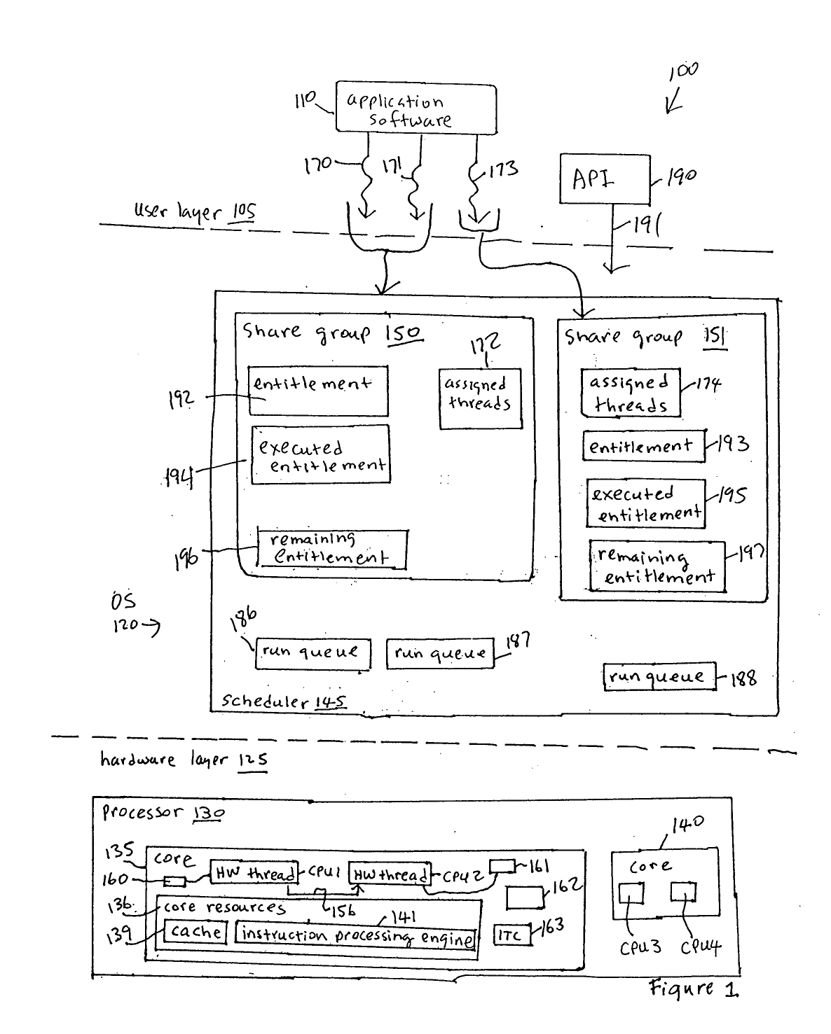

FIG. 1 is a block diagram of a system (apparatus) 100 in accordance with an embodiment of the invention. The system 100 is typically a computer system that is in a computing device. A user layer 105 will have an application software 110 that will run in the system 100. It is understood that more than one application software can run in the user layer 105. A kernel layer 115 includes an operating system 120 with various features as described below. A hardware layer 125 includes a processor 130. The processor 130 includes a CPU core (i.e., processor core) 135. Alternatively, the processor 130 can be multi-core processor by having with multiple processor cores 135 and 140, although the cores in the processor 130 may vary in number in other examples. Since the core 135 includes the hardware threads CPU1 and CPU2, the core 135 is a multithreaded core. The number of hardware threads in a core 135 can vary. A core 135 also has resources 136 which include, for example, a cache 139, instruction processing engine 141, and other known core resources.

Hardware threads CPU1 and CPU2 will be used to discuss the following example operation of an embodiment of the invention, although this example operation can also apply to hardware threads CPU3 and CPU4 in core 140 as well. The processor 130 will include one or more additional cores 140 if the processor 130 is a multi-core processor. Hardware threads CPU1 and CPU2 are sibling hardware threads because they are in the core 135, while CPU3 and CPU4 are sibling hardware threads because they are in the core 140. Typically, the operating system (OS) 120 is booted with hardware multithreading enabled in the hardware layer 125 for the cores. As the OS 120 boots, the OS 120 views each hardware thread CPU1 and CPU2 as multiple CPUs.

In accordance with an embodiment of the invention, the sibling hardware threads CPU1 and CPU2 from the same core 135 are only allowed to execute the application threads (software threads) from the same fair share group (e.g., fair share group 150), in order to provide accurate measurement of the scheduling share distribution among the fair share groups. This solution provides the same level of accuracy in fair share scheduling for hardware multithreaded systems as in the fair share scheduling that exists in hardware systems that are hardware single threaded.

Various methods are known to those skilled in the art for assigning application threads (software threads) to a fair share group. One example of a product that permits assigning of application threads to fair share groups is the HP-UX operating system which is commercially available from HEWLETT-PACKARD COMPANY. In FIG. 1, assume as an example, that the application threads 170 and 171 belong to the first fair share group 150. The assigned threads attributes 172 will permit the application threads 170 and 171 to belong to the fair share group 150. Assume further in this example that the application thread 173 belongs to the second fair share group 151. The assigned threads attributes 174 will permit the application thread 173 to belong to the fair share group 151.

Within the fair share scheduler 145, each hardware thread within a CPU core is identified as either a primary hardware thread or secondary hardware thread. In the example of FIG. 1, the hardware thread CPU1 is set as a primary hardware thread by a priority value 160, and the hardware thread CPU2 is set as a secondary hardware thread by a priority value 161. When the primary hardware thread CPU1 schedules a software thread (task) from a fair share group, CPU1 will note that the software thread from that fair share group will be executed. The secondary hardware thread CPU2 is then only allowed to schedule the execution of a software thread (task) from that same fair share group. If another software thread (task) in the same fair share group cannot be found, then this secondary hardware thread CPU2 will execute one of the CPU (processor) yielding operations (such as, e.g., PAL_HALT_LIGHT or hint@pause) by use of, for example, a halt/yield function 162 which is also described in commonly-assigned U.S. patent application Ser. No. 11/591,140, by Scott J. Norton, et al., entitled “DYNAMIC HARDWARE MULTITHREADING AND PARTITIONED HARDWARE MULTITHREADING”, which is hereby fully incorporated herein by reference. The secondary hardware thread CPU2 will remain in this yield mode until either a task becomes available to run in the same fair share group 150 or until the primary hardware thread CPU1 moves to a different share group 151 in order to execute tasks in that share group 151. When a software thread becomes available to run in the same fair share group or when the primary hardware thread CPU1 moves to a different share group, the CPU2 will terminate the yielding operation. An example PAL_HALT_LIGHT function places a hardware thread in a halt state and is known to those skilled in the art. An example yield function is the hint@pause instructions which trigger a hardware thread to yield execution to another hardware thread of the core and is known to those skilled in the art. The use of the yielding operations to place a hardware thread in a yield mode is disclosed in the above-cited U.S. patent application Ser. No. 11/591,140.

When the primary hardware thread CPU1 moves to a different fair share group, CPU1 will deliver a scheduling interrupt 156 to the secondary hardware thread CPU2. This will cause the secondary hardware thread CPU2 to stop running a current software thread (task) and to search for a software thread (task) in the different fair share group that is now being run by the primary hardware thread CPU1.

In an embodiment of the invention, software threads assigned the same share group are scheduled on the same CPU core. In the example of FIG. 1, the software threads 171 and 173 (both assigned to share group 150) are scheduled on the CPU core 135. The hardware thread CPU1 will choose the software thread 170 from a run queue 186 and execute that software thread 170. The hardware thread CPU2 is a sibling hardware thread of CPU1. Similarly, the hardware thread CPU2 will choose the software thread 171 from a run queue 187 and execute that software thread 171. A hardware thread selects software threads to execute from a fair share group by selecting the software threads from the run queue (or queues) that are associated with the share group, as discussed in the example above. Therefore, the share group 150 receives the benefits of the multi-threading operations of CPU core 135. By scheduling all software threads of a share group on the same CPU core, the share group will be entitled to the entire or 100% of the CPU core resources (e.g., CPU cycles). Therefore, an embodiment of the invention advantageously provides entitlement of the CPU core resources to the fair share groups.

As another example, assume that the fair share group 151 is scheduled on the CPU core 135. If there is only the single software thread 173 to be executed in the share group 151, then the hardware thread CPU1 will choose the software thread 173 from a run queue 188 and execute that software thread 173. Since another software thread (task) in the same fair share group 151 is not found, then the secondary hardware thread CPU2 will execute one of the CPUs yielding operations (such as, e.g., PAL_HALT_LIGHT or hint@pause). The secondary hardware thread CPU2 will remain in this yield mode until either a task becomes available to run in the same fair share group 151 or until the primary hardware thread CPU1 moves to a different share group to execute tasks in that different share group.

A standard application program interface (API) 190 may be used, via system calls 191, to set the attributes of a fair share group and to create one or more fair share groups, and to set the entitlements in a fair share group. The entitlements 192 and 193 for share groups 150 and 151, respectively, are attributes that indicate the percentages that the share groups will be entitled on the CPU core 135 resources (e.g., CPU cycles). The entitlement 192 provides the CPU core resources to the fair share group 150 at, e.g., approximately 60% of the CPU core 135 resources. The entitlement 193 provides the CPU core 135 resources to the fair share group 151 at, e.g., approximately 40% of the CPU core resources. Other entitlement values may be set for the share resources 150 and 151.

The executed entitlements attributes 194 and 195 are typically counter values that indicate the amount of entitlements that the fair share groups 150 and 151, respectively, have used. The remaining entitlements attributes 196 and 197 are counter values that indicate the amount of entitlements that the fair share groups 150 and 151, respectively, have not yet used and are available. The primary hardware thread CPU1 can maintain statistics of how much time each fair share group has executed and also sets this value in the executed entitlements attribute 194 and 195. For example, a standard Interval Timer Counter (ITC) 163 may be used to track the time that each fair share group has been executed by a hardware thread. Time accounting on hardware multithreading when yield operations are performed by hardware threads are discussed in, for example, commonly-assigned U.S. patent application Ser. No. 11/554,566, which is hereby fully incorporated herein by reference. The counting of processor cycles that are charged to hardware multithreading is disclosed in, for example, commonly-assigned U.S. patent application Ser. No. 11/______, concurrently filed herewith, by Hyun Kim and Scott J. Norton, entitled, “ACCURATE MEASUREMENT OF MULTITHREADED PROCESSOR CORE UTILIZATION AND LOGICAL PROCESSOR UTILIZATION”, which is hereby fully incorporated herein by reference. This hardware thread CPU1 will maintain statistics of how much time the task (software thread) was on the CPU core 135 (as opposed to actually running on the core 135). This time will include the time spent running software threads (tasks) from both the primary hardware thread CPU1 and secondary hardware thread CPU2 as well as time when the hardware thread has already selected the software thread from a run queue but is not yet executing the software thread (i.e., time that the software thread is idle and not yet being executed). This idle time (i.e., wait time) is due to the context switching that occur between the multiple hardware threads in a hardware multithreaded system. Fair share scheduling decisions can then be made on these statistics. Therefore, the fair share scheduling decisions will be core-based because the counted time value indicates on how much time the software threads were on a CPU core. This fair share scheduling on hardware multithreaded systems will be accurate as the fair share scheduling that is used in a single threaded hardware system because the idle time of a software thread on a core is also counted in the executed entitlement value 194. Therefore, the entitlement value 194 provides an accurate measurement of the scheduling share distribution among the fair share groups, and this accurate measurement will improve the testing, diagnostics, and design of fair share schedulers.

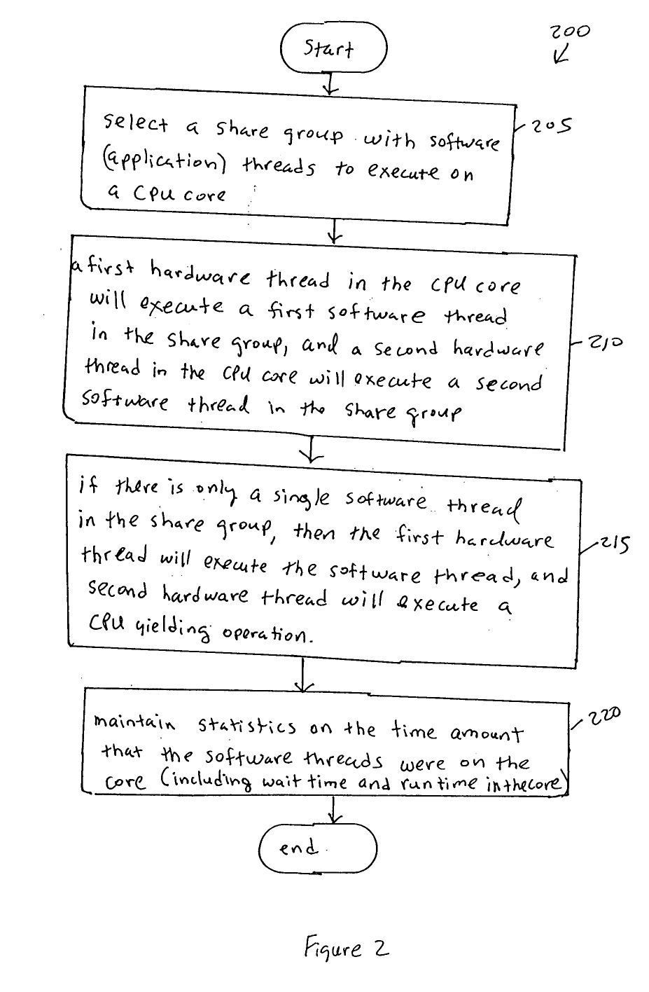

FIG. 2 is a block diagram of a method 200, in accordance with an embodiment of the invention. In block 205, a CPU core selects a share group with software (application) threads to execute on the CPU core.

In block 210, a first hardware thread CPUL in the CPU core will execute a first software thread in the share group, and a second hardware thread CPU2 in the CPU core will execute a second software thread in the share group.

In block 215, if there is only a single software thread in the share group, then the first hardware thread CPU1 will execute the software thread, and the second hardware thread will execute a CPU yielding operation.

In block 220, the CPU core maintains statistics on the time amount that the software threads were on the core. This time amount includes wait time and run time in the CPU core by the software threads. This time amount will include the time spent running software threads (tasks) from both the primary hardware thread CPUL and secondary hardware thread CPU2.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for fair share scheduling with hardware multithreading, the method comprising:
executing, by a first hardware thread in a processor core, a first software thread belonging to a fair share group; and
permitting a second hardware thread in the processor core to execute a second software thread if that second software thread belongs to the fair share group.

2. The method of claim 1, further comprising:
assigning the first hardware thread as a primary hardware thread and the second hardware thread as a secondary hardware thread.

3. The method of claim 1, further comprising:
executing, by the second hardware thread, a processor yielding operation if a second software thread in the share group is not available to run on the second hardware thread.

4. The method of claim 3, further comprising:
terminating the yielding operation when another software thread becomes available to run in the same fair share group.

5. The method of claim 3, further comprising:
terminating the yielding operation when the first hardware thread moves to a different share group.

6. The method of claim 1, further comprising:
when the first hardware thread executes a software thread from a second fair share group, delivering a scheduling interrupt to the second hardware thread so that the second hardware thread will stop running a current software thread and search for a software thread in the second fair share group.

7. The method of claim 1, wherein the software threads in a fair share group are scheduled to be executed in the same processor core.

8. The method of claim 1, further comprising:
maintaining statistics of a time amount during which the software threads were on the core, including execution time on the first hardware thread and second hardware thread and wait time.

9. An apparatus for fair share scheduling with hardware multithreading, the apparatus comprising:
a processor core comprising a first hardware thread and a second hardware thread, wherein the first hardware thread is configured to execute a first software thread belonging to a fair share group, and wherein the second hardware thread is configured to execute a second software thread if that second software thread belongs to the fair share group.

10. The apparatus of claim 9, wherein the first hardware thread is assigned as a primary hardware thread and the second hardware thread is assigned as a secondary hardware thread.

11. The apparatus of claim 9, wherein the second hardware thread executes a processor yielding operation if a second software thread in the share group is not available to run on the second hardware thread.

12. The apparatus of claim 11, wherein the second hardware thread terminates the yielding operation when another software thread becomes available to run in the same fair share group.

13. The apparatus of claim 11, wherein the second hardware thread terminates the yielding operation when the first hardware thread moves to a different share group.

14. The apparatus of claim 9, wherein the first hardware thread delivers a scheduling interrupt to the second hardware thread so that the second hardware thread will stop running a current software thread and search for a software thread in the second fair share group, when the first hardware thread executes a software thread from a second fair share group.

15. The apparatus of claim 9, wherein the software threads in a fair share group are scheduled to be executed in the same processor core.

16. The apparatus of claim 9, wherein the processor core maintains statistics of a time amount during which the software threads were on the core, including execution time on the first hardware thread and second hardware thread and wait time.

17. An apparatus for fair share scheduling with hardware multithreading, the apparatus comprising:
means for executing, by a first hardware thread in a processor core, a first software thread belonging to a fair share group; and
means for permitting a second hardware thread in the processor core to execute a second software thread if that second software thread belongs to the fair share group.

18. An article of manufacture comprising:
a machine-readable medium having stored thereon instructions to:
execute, by a first hardware thread in a processor core, a first software thread belonging to a fair share group; and
permit a second hardware thread in the processor core to execute a second software thread if that second software thread belongs to the fair share group.
